(19) United States
(12) Patent Application Publication
(10) Pub. No.: US 2007/0124536 A1
(43) Pub. Date: May 31, 2007

(54) TOKEN DEVICE PROVIDING A SECURE WORK ENVIRONMENT AND UTILIZING A VIRTUAL INTERFACE

(75) Inventor: Todd Alan Carper, San Francisco, CA (US)

Correspondence Address: PAUL, HASTINGS, JANOFSKY & WALKER LLP, P.O. BOX 919092, SAN DIEGO, CA, 92191-9092, US

(73) Assignee: ELECTRONIC PLASTICS, LLC, Las Vegas, NV (US)

(21) Appl. No.: 11/558,103

(22) Filed: Nov. 9, 2006

Related U.S. Application Data
(60) Provisional application No. 60/734,793, filed on Nov. 9, 2005.

(51) Int. Cl. G06F 12/00

(52) U.S. Cl. 711/115

(57) ABSTRACT

A system, in accordance with one embodiment, comprising a host device including a display, the host device running a client application; and a token device coupled to the host device through an interface, the token device including a processor for running a token device application, the token device application providing image information over the interface to the client application running on the host device, the client application displaying an image on the display of the host device corresponding to the image information provided from the token device.

This application claims priority to U.S. Provisional Patent Application No. 60/734,793, filed Nov. 9, 2005, to Carper, entitled TOKEN COMPUTER PROVIDING A SECURE WORK ENVIRONMENT AND UTILIZING A VIRTUAL INTERFACE, which application is incorporated herein by reference in its entirety.

### BACKGROUND OF THE INVENTION

1. Field of the Invention

The present invention relates to token devices. More specifically, the present invention relates to token devices for use with a host computer.

2. Discussion of the Related Art

Working in a mobile fashion is often accomplished by carrying a portable storage device (e.g., a Universal Serial Bus (USB) Storage Device) containing the files which a person is presently working on. When access to files located on the USB device is desired, the USB device is connected to an available computer (Macintosh, Windows, Linux, PDA) at a hotel, cafe, customer office, etc., and the USB device appears as a drive on the computer allowing the files to be accessed.

In some implementations of the USB storage device, a password maybe required to gain access to the stored files and applications. Additionally, each file or application may be encrypted to provide additional security against the files being stolen.

This method of transporting files is convenient because it is not necessary to carry a laptop everywhere. The user simply sits at an available computer and connects the USB storage device and by using the applications available on the hosting computer or the USB device, accesses the files on the USB device.

Security for personal files, work files, and many other applications is becoming more and more of a concern and a requirement for many different users. Thus, by the ability to password-protect the USB storage device and/or each file and application on the USB device provides security in the event the USB device is lost or stolen. However, anytime a file is accessed on a computer (especially a computer that is not owned by the user such as is typical when using a USB device) there are a number of potential problems.

One problem, for example, is that files and/or applications on the USB device can become open to viruses. In operation, once the appropriate password is provided (if one is required) the files and applications that are stored on the USB device are directly available to the computer to which the USB device is connected. Once the computer is able to access the files, any application, valid or viral, has the ability to access and modify the stored files and applications. Inserting the USB storage device into a computer that is infected with viruses can cause some or all of the files and applications stored on the USB storage device to become infected.

A second problem is that when a USB device is used with a host computer and files and/or applications stored on the USB device are accessed from the computer, copies of information (i.e., all or part of the files and/or applications) are left behind even after the USB device is removed from the host computer. Even in the case of a virus-free machine, once an application is launched (e.g., a word processor) to edit, print, read, or copy a file stored on the USB device, the file and application are brought into the memory of the hosting computer. At this point, the document may be temporarily cached to disk (normal operation for the computer) or may be copied from memory by a program monitoring all system activity (not necessarily a viral Trojan). Additionally, the application will actually be running on the host computer. These various occurrences mean that even after the file is closed or printing has completed and the USB device removed from the host computer, one or more full copies or portions of the file and/or application may still remain on the host computer. The copies or remnants may be recovered into a viewable or usable form utilizing publicly available recovery tools. Thus, even though the files are stored on the USB device (possibly using one or more security models), the user has a false sense of security regarding the privacy and the integrity of the files and applications.

Another existing approach to providing transportable work areas involves using technology from U3 LLC of Redwood City, Calif. (www.u3.com). U3 provides technology for installing special stripped down versions of applications that are designed to be launched from the portable USB storage device. For example, a stripped down version of Microsoft Word could be stored on the USB device. This system provides the ability to transport both files and needed applications. By carrying the applications in the memory of the USB device, the user is assured of having the proper application available even if the USB device connects to a host device that does not have the application installed. However, in this system the USB storage device is still vulnerable to viruses and when running the applications installed on the USB storage device, the application actually utilizes the host computer processor and executes in the main memory of the host computer. Additionally, the files are also loaded into the memory of the host computer while they are being accessed. Thus, the above mentioned problems associated with viruses and leaving behind copies of files are still present in the U3 system. The U3 approach does introduce some nice usability features by automatically loading a program that is located on the USB storage device when the USB device is inserted into the host computer. The program provides an interface so that other installed applications can be easily selected from the existing host computer interface (e.g., from the Windows START menu). The U3 system is targeted for use with Windows based computer systems.

Thus, what is needed is a secure method of accessing files and running applications that are stored on a token device.

### SUMMARY OF THE INVENTION

Various embodiments herein provide for a token device running a specialized application wherein a user can interact with the specialized application on the token device through a client application running on a host device.

One embodiment can be characterized as a token device comprising a memory; an interface for coupling the token device to a host device; and a processor coupled to the memory, the processor running a token device application stored in the memory of the token device, the processor providing image information to the host device over the interface, the image information for rendering an image corresponding to the application, said image information being transmitted to a client application for rendering on a display of the host device.

Another embodiment can be characterized as a system comprising a host device including a display, the host device running a client application; and a token device coupled to the host device through an interface, the token device including a processor for running a token device application, the token device application providing image information over the interface to the client application running on the host device, the client application displaying an image on the display of the host device corresponding to the image information provided from the token device.

A subsequent embodiment includes a method of operating a token device comprising coupling the token device to a host device through an interface; running a token device application on the token device; generating image information; and sending the image information to the host device through the interface, the image information being rendered by a client application running on the host device.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating a portable token device in accordance with one embodiment;

FIG. 2 is a block diagram illustrating a portable token device coupled to a host computer in accordance with one embodiment;

FIG. 3 is a flow diagram illustrating a method of using a portable token device with a host computer in accordance with one embodiment;

FIG. 4 is a block diagram illustrating a portable token device utilized with a banking application in accordance with one embodiment;

FIG. 5 is a block diagram illustrating a portable token device utilized with a point of sale terminal in accordance with one embodiment; and

FIG. 6 is a diagram illustrating a screen shot of various applications being utilized in a virtual interface application accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

Some embodiments described herein provide for a secure and portable work environment that can meet the demands of various users. The token devices, in various embodiments provide one or more the following features: keep files secure, allow a user to work with the files by having the necessary applications resident in the portable environment, prevent files from being cached on a host machine, provide a highly portable form factor (e.g., a smart card or USB device), are immune from infection by host machines, and can operate with Windows, Linux, Macintosh, PDA host computers or many other types of host computers running various operating systems.

One embodiment includes a portable device (e.g., USB form factor or smart card) that contains a processor, one or more applications stored in memory, one or more files stored in memory, and a client application for running a virtual interface through a host computer. In one embodiment, the portable device includes an operating system. In some embodiments, the device includes a single connection interface (e.g., USB, smart card, network) and does not include a keyboard, mouse, display or other input device. In operation, the user will interact with the portable token device via a client application supporting the virtualization of the device interface. The processing of token device applications and files on the portable device occurs locally to the portable device and not on the host device. No file data, applications (other than the virtual interface application), or computing operations are performed on, cached on, or transferred to the host computer.

Another embodiment includes a portable token device containing a microprocessor with an interface (e.g., a USB, Smart Card, or network interface) which when connected to a host computer provides a secure computing environment supporting applications such as secure on-line banking, a secure personal workspace, a secured custom point-of-sale interface, word processing, spreadsheet, file viewer and any other application.

Another embodiment includes a secure processor such as those commonly utilized in smart cards, one or more token device applications oriented to the targeted use, and an operating system such as the one described, for example, in U.S. Pat. No. 6,390,374, issued May 21, 2002, to Carper et al., entitled SYSTEM AND METHOD FOR INSTALLING/DE-INSTALLING AN APPLICATION ON A SMART CARD, which patent is incorporated herein by reference in its entirety. Alternative operating systems can also include, for example, the Contiki operating system described at http://en.wikipedia.org/wiki/Contiki, or a virtual server such as the VNC server described at http://sourceforge.net/projects/vnc-tight. The components are assembled in a smart card or USB token form factor. Additionally, the token device can be, for example, a biometric device such as is described in, for example, U.S. Provisional Patent Application No. 60/806,494, filed Jul. 3, 2006, to Carper et al., entitled BIOMETRIC EMBEDDED DEVICE, which provisional application is incorporated herein by reference in its entirety.

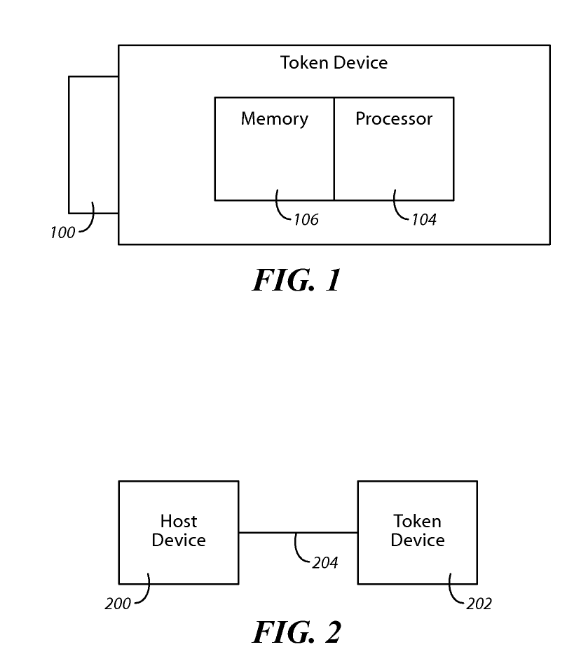

Referring now to FIG. 1 a block diagram is shown illustrating a portable token device in accordance with one embodiment. Shown is an interface 100, a processor 104, and memory 106. The device can have various other components including, for example, additional processors, biometric components and a power source.

The portable token device can be in the form of a USB device, a Smart Card, or other easily portable small embedded device. In general, the portable token device will not include a keyboard, a display screen or other input/output functionality except as is provided through the interface 100.

The memory 106 can include both ROM, Flash memory and/or RAM in accordance with various embodiments. The memory can include one or more physical memory storage devices and/or memory directly associated with a processor circuit. In contrast to normal USB devices, the portable token device includes the processor 104 for running token device applications on the portable token device. The applications will be referred to herein as specialized applications, token device applications and/or virtual server applications. Each of these simply refers to an application that is executing on the processor 104 of the token device.

The processor 104 is a specialized micro-processor in accordance with one embodiment. The processor 104, however, can be many various types of processors such as those described above herein. Optionally, the processor 104 can include a secure processor that runs an operating system or a specialized secure micro-processor designed for running a specialized application.

In one embodiment, the portable token device is used for one or more specialized applications (e.g., a banking application, a file viewer, a file editor, or a financial transaction application). The specialized application (also referred to here as the token device application) is stored in the memory 106 of the portable token device and run by the processor 104. Additionally, the portable token device can store one or more files in the memory 106 and can also optionally store a client application that is designed to run on a host computer. The client application provides a virtual interface for the specialized application running on the processor 104 of the portable token device. In this manner, the host computer can be utilized to interact with the specialized application. For example, a user can use the keyboard and mouse of the host computer in order to interact with the specialized application running on the token device.

Referring next to FIG. 2, a block diagram is shown illustrating a portable token device coupled to a host computer in accordance with one embodiment. Shown is a host device 200, a token device 202, and an interface 204.

The host device 202 is coupled to the token device 202 through the interface 204. The interface 204 is, for example, a USB interface, a Smart Card interface, or network interface. The interface 204 can also be a wired or wireless interface in accordance with various embodiments. The interface provides I/O functionality between the host device 200 and the token device 202. Additionally, in some embodiments, power is provided from the host device 200 to the token device 202 over the interface 204. Alternatively, the token device 202 includes an on-board power source such as a battery or solar cell.

The token device 202 is, for example, the token device described above with reference to FIG. 1. As described above, the token device 202 stores a specialized application that runs on the token device 202. The specialized application can also be thought of, and will be referred to herein, as a virtual server. Optionally, the token device 202 also stores a client application that is loaded onto the host device 200 through the interface 204 when the token device 202 is connected to the host device 200. The client application can also be thought of, and will be referred to herein, as a virtual client. It is preferred that the client application be stored on the token device 202 such that anytime the token device is coupled to any host device 200, the client application can easily be transferred to the host device 200. However, in alternative embodiments, the client application can be stored on the host device 200 prior to being coupled to the token device 202 or the host device 200 can download the client application from a remote source.

The virtual server (i.e., specialized application(s)) communicates with the virtual client (i.e., client application) through the interface 204. In one embodiment, the virtual client is developed using Java so that it will execute on most computer systems, including, for example, Personal Digital Assistants (PDA), telephones, and computers without being dependent upon a particular operating system. However, the client device can be developed using other technologies and can be built platform specific if desired.

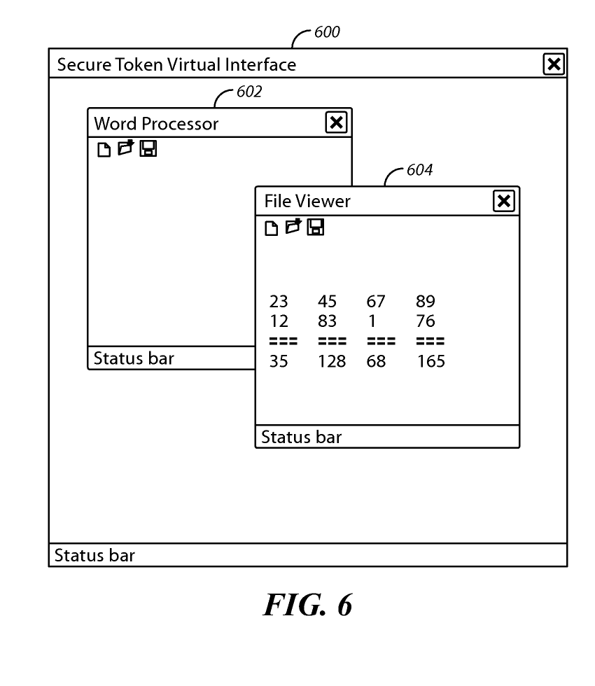

In operation, the virtual client running on the host device 200 communicates with the virtual server running on the token device 202. The virtual client displays a virtual screen within an application window on the host device 200. An exemplary screen shot of the virtual client and virtual screen is shown and described below with reference to FIG. 6. Keyboard and mouse actions are collected by the virtual client and forwarded to the virtual server. This allows a user to interact with the specialized application that is running on the token device even though the token device generally does not include any inputs such as, for example, a keyboard or mouse. For example, the specialized application could be a file editing program and the user could edit a text file that is stored on the token device 202. While the user can see the text file in the virtual screen, the host device 200 does not have access to a copy of the text file. The data that the host device 200 receives is image data from the token device 202 and does not actually obtain a copy of the text file. Optionally, the virtual client may support providing, for example, access to a network and/or printing services.

The virtual screen is, for example, a window on a display device of the host device 200. The contents of the virtual screen are updated in response to image data provided from the virtual server to the virtual client. In order to update the virtual screen that is shown on the display device of the host device 200, the specialized application running on the token device 202 provides image information to the virtual client. The virtual client then updates the virtual screen. It should be understood however, that the host device 200 does not access or run the specialized application running on the token device 202. The application and/or any files on the token device 202 are kept completely secure and isolated from the host computer 200. This prevents the specialized application from getting any viruses or having to disclose data to the host device 200. Thus, when the token device 202 is removed from the host device 200, there are no copies (whole or partial) of the information left behind on the host device 200.

In one embodiment, a drive that contains the virtual client application is published to the host device 200 at the time when the token device 202 is connected to the host device 200. This allows the host device 200 to load and run the virtual client application upon being connected to the token device. Optionally, the token device 202 may publish an additional drive that is read only or read/write. The additional drive can be used to access or store files or applications. For example, a file could be copied from the host device 200 and stored on the token device 202. This may not be desirable in some applications as it may be possible to copy a virus onto the token device 202.

The token device 202 can be password protected and/or protected by requiring biometric identification. One example of a biometric token is described in U.S. Provisional Patent Application No. 60/806,494, filed Jul. 3, 2006, to Carper et al., entitled BIOMETRIC EMBEDDED DEVICE, which provisional application is incorporated herein by reference in its entirety. One problem with having a password protected token device 202 as compared to a biometric device is that the host computer could potentially have a “key logger” program that could capture the key strokes (or mouse clicks) as a user entered their password. One solution to this, in accordance with the present embodiment, is to have the specialized application running on the token device present a keypad to the user and have the user enter their password using the mouse. The keypad can be scrambled so that the numbers appear in different places in the keypad each time a password is required. This solution will prevent a “key logger” program from recording any meaningful data regarding the user's password. Because the specialized application that is running on the token device 202 is presenting the keypad, the host computer 200 can not track what keypad is presented to the user.

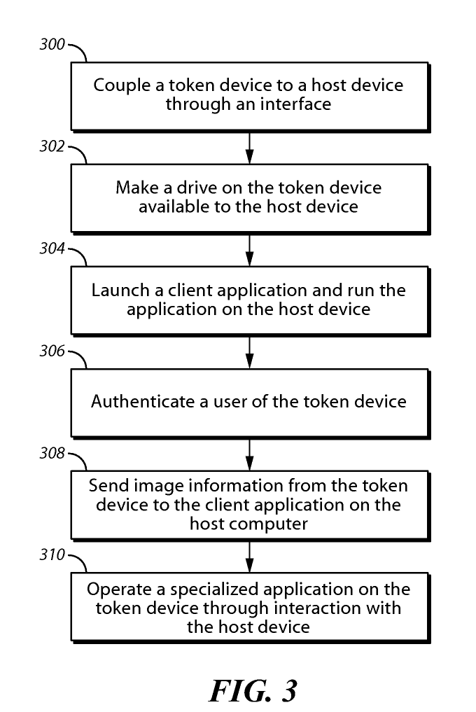

Referring next to FIG. 3, a flow diagram is shown illustrating a method of using a portable token device with a host computer in accordance with one embodiment.

In step 300, a token device is coupled through an interface to a host computer. For example, the token device is inserted (plugged) into a USB port on a host computer. Next in step 302, a drive (e.g., a read-only drive) is provided to the host computer. The drive contains one or more application files and preferably contains the virtual interface client. As described above, for greatest compatibility the virtual client application is preferable written in Java, however can be written specifically for the target computing environment using many different technologies. Additionally, as described above, the virtual client application can be already located on the host computer or the host computer can download the virtual client application from a source other than the token device.

In step 304, if the virtual client application is located on the drive, a user can launch the virtual client application, for example, by double clicking on the virtual client application. Alternatively, the virtual client application can be programmatically launched when the token device is connected to the host computer through the interface.

Following, in step 306, using the virtual client application, the user can provide an appropriate password to login to the token device. Alternatively, biometric authentication can be utilized to authenticate the user. In step 308, image information is sent from the token device to the client application and a view of the desktop or specialized application that is running on the token device will appear in a window within the client application. For example, a window within the virtual client application will display a desktop environment or a window for specialized application running on the token device. If the token device only contains a single specialized application, the application may automatically start and there is no need to have a desktop. However, if multiple specialized applications or multiple files are stored on the token device, a desktop may be convenient for the user. Again, it should be noted that the specialized application is running on the token device and is not loaded to the host computer. The host computer is only running the virtual client application.

Next, in step 310, the specialized application operates like any other computer application. That is, the user can interact with the application using the host device as an interface. For example, the user can move the mouse or type on the keyboard in order to interact with the application running on the token device. Optionally, a network (e.g., Internet) connection of the host computer can be tunneled through the USB connection and made available to the token device. The network connection can be utilized, for example, for accessing a remote server or printing. Optionally, although it may be considered a security risk, an additional read/write drive located on the token device can be made available to copy files to and from the token device. As another option, a read only drive can be made available to permit a file to be transferred from the token device to the host computer. In yet another option, the token device operates a web server which enables selected files to be published in a read only manner that could be accessed by the host computer.

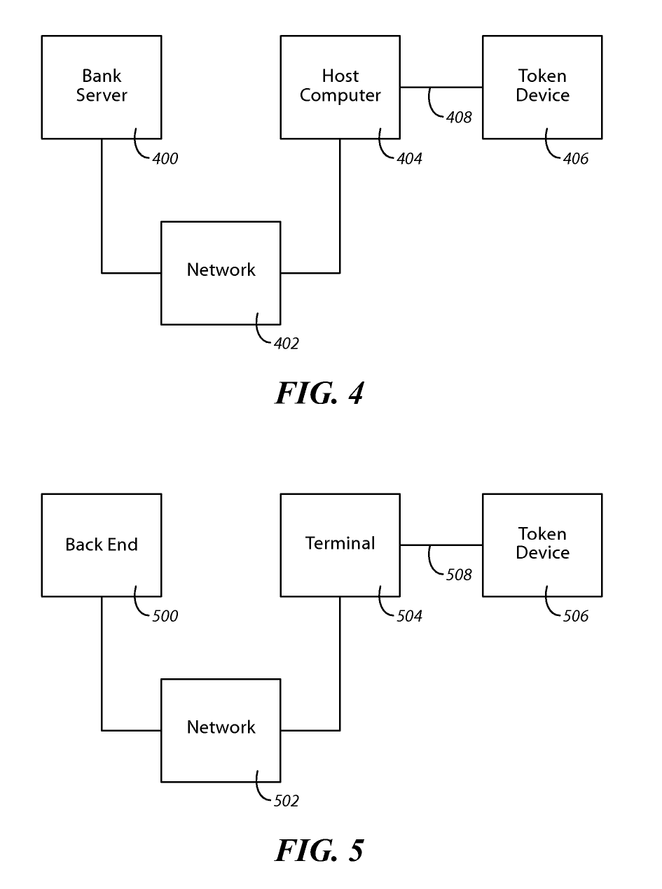

Referring next to FIG. 4, a block diagram illustrating a portable token device utilized with a banking application in accordance with one embodiment. Shown is a bank server 400, a network 402, a host computer 404, a token device 406 and an interface 408.

The token device 406 is coupled to the host computer 404 through the interface 408. The host computer 404 is coupled to the bank server 400 through the network 402 (e.g., the Internet or directly through a modem).

One problem with typical web browser access to banking is that while it is very convenient, it is not necessarily a very secure manner of accessing confidential and sensitive information. Another problem is that brute force sampling of user account names or numbers by unauthorized users with invalid passwords can very quickly cause accounts to be locked-out (due to too many failed attempts) thus, prohibiting valid users the ability to gain access to the banking information. Additionally, Trojan programs running on a user's computer can capture sensitive information (e.g., password or username). Yet another problem is that the local disk cache of the computer may store sensitive information. Furthermore, anyone can attempt access from any computer and there is no physical device or card required. Yet another problem is the web site link can be spoofed and cause the user to divulge their banking credentials when attempting to log into their account.

In order to overcome the above problems and other problems associated with traditional online banking, the system shown in FIG. 4 can be implemented. The token device 406 stores, for example, a single specialized application (e.g., a banking application). One or more files can also be stored in a memory of the token device 406. The bank creates or adopts an application facilitating secure access to the bank server. The specialized application created by the bank is securely installed on the token device 406. Preferably, the ability to install additional applications onto the token device is then disabled. However, the bank application may optionally allow updates to the installed software. Updating of applications on a token device is described, for example, in U.S. Pat. No. 6,390,374, issued May 21, 2002, to Carper et al., entitled SYSTEM AND METHOD FOR INSTALLING/DE-INSTALLING AN APPLICATION ON A SMART CARD, which patent is incorporated herein by reference in its entirety. Optionally, it is not possible to access the token device 406 directly or run any application other than the bank certified application on the token device.

In operation, the token device 406 is coupled to the host computer 404 through the interface 408. For example, the token device 406 is inserted into a USB interface of the host computer. When the token device 406 is inserted, power is applied to the token device 406 (via the USB interface, for example) and the processor of the token device starts running. If the token device includes an operating system, the operating system boots up. In one embodiment, the banking application starts such that the operating system and banking application are up and running and awaiting user interaction. If more than one application can be run on the token device 406 a user may be presented with a desktop or other means of selecting an application or file.

Next, for example, a drive appears on the desktop of the host computer that looks like a normal USB storage device. However, preferably, only a single application (which can not be deleted) resides on the drive. Optionally, other files or applications could also be stored in the common area and possibly kept as read only files. For example, the user manual for the application may be stored in this area of memory. Next, the application is launched, for example, programmatically or by a user selecting the application. The application acts as a virtual client application such as the virtual client application described herein above. Upon being launched a normal application window opens on the host computer 404 and provides a virtual interface to the operating environment running on the token device 406. For example, a virtual interface allows a user to interact with the banking application that is running on the token device 406.

A network bridge is created to connect the host computer's internet connection to the banking application on the token device 406. The internet bridge enables the banking application to communicate over the network (e.g., Internet or local network) with the bank server 400. The banking application on the token device would, for example, utilize the network bridge to connect directly to the remote banking server 400. For an application such as banking, where privacy and security are required, the transmission of information between the bank server 400 and the token device 406 should be encrypted so that it cannot be read by any intermediary. The host computer 404 operates simply as a conduit to route the communications between the token device 406 and the bank server 400. The host computer 404 is unable to view or modify (without corrupting the integrity) the transferred information. Because the banking application is running on the processor of the token device 406, the host computer 404 has no access to any information that is not encrypted. Furthermore, the banking application and optionally the operating system are running completely on the token device 406, thus, there is no trace of the application operating on the host computer 404. Optionally, the use of a biometric sensor on the token device 406 enables good protection against theft and misuse. One preferred embodiment of integrating a biometric sensor with a token device is described in U.S. Provisional Patent Application No. 60/806,494, filed Jul. 3, 2006, to Carper et al., entitled BIOMETRIC EMBEDDED DEVICE, which provisional application is incorporated herein by reference in its entirety.

The system of FIG. 4 optionally allows a bank to distribute a token (e.g., a smart card) that can be used for financial transactions and that can also be used for secure network banking. Such security is not currently available in online banking systems. It should be understood that the operation described above is exemplary and more or fewer steps are implemented depending upon the desired system operation.

Referring next to FIG. 5 a block diagram is shown illustrating a portable token device utilized with a point-of-sale (POS) terminal in accordance with one embodiment. Shown is a back end 500, a network 502, a terminal 504, a token device 506 and an interface 508.

The token device 506 is coupled to the terminal 504 through the interface 508. The terminal 504 is coupled to the back end 500 through the network 502 (e.g., Internet or direct modem line).

In typical POS terminals, various methods of payments are accepted. Typically, magnetic-stripe, contact smart card, or contactless smart cards are utilized by consumers. The smart card based systems are considered to be more secure than the magnetic-stripe systems. While this may be true, the terminal is often overlooked as an attack point in many systems. Many terminals can have the internal software modified so that they appear to function properly but actually perform additional operations unseen by the consumer and vendor. For example, the terminal software can be modified to record transaction information. Additionally, the consumer cannot be certain that the amount displayed on the screen is the actual amount that is submitted for approval (either direct over the phone line in the case of magnetic-stripe) even when using a smart card based model. Further, the terminal may access and store or use other card information unknown to the consumer.

The system shown in FIG. 5 overcomes these and other problems associated with financial transaction systems. Preferably, the token device 506 is a secure token computer in the form-factor of a smart card and utilizes the smart card interface as the interface 508. The terminal 504 (also referred to herein as the POS terminal 504) is modified to detect the presence of a secure token computer in accordance with the embodiments described herein. When the POS terminal 504 identifies the token device 506, a portion of a display (not shown) of the POS terminal 504 is used to present a virtual interface to the user. The terminal is running a client application that shows the virtual interface. The virtual interface is used to display information related to a financial transaction application that is running on the token device 506. Thus, the token device 506 is controlling what is displayed in the virtual interface by sending image information to the terminal. The image information is used by the client application to update the virtual interface. In another area of the display of the POS terminal 504 (e.g., above the virtual interface) the amount of the transaction is displayed. The amount can also be sent as part of a message to the token device 504.

Following, the user can interact with the specialized transaction application, for example, using a keypad on the POS terminal 504. In this embodiment, the POS terminal 504 is acting as a host computer. Similarly to that described above, the token device can be protected using a password or pin or by using biometric identification. The terminal device 504 is used to interact with the financial transaction application running on the token device. Next, the user will generally accept the amount displayed, select the desired method of allowed payment, and then submit the transaction for recording and transmission. Encrypted communication is preferably utilized so that the terminal has no ability to modify, or even examine the encrypted transaction information.

It should be understood that the operation above is exemplary and additional or few steps can be used to modify the operation described. For example, various communication steps between the back end 500 and the token device 506 can be implemented to authenticate the transaction.

Various secure methods of communication can be utilized in the banking applications and point of sale terminal applications described above with reference to FIGS. 4 and 5. Some of the various communication methods and systems that can be utilized in accordance with the embodiments described above are provided in U.S. Provisional Patent Application 60/862,381, filed Oct. 20, 2006, to Carper et al., entitled DECENTRALIZED SECURE TRANSACTION SYSTEM, which application is incorporated herein by reference in its entirety.

Referring next to FIG. 6 a diagram is shown illustrating a screen shot of various applications being utilized in a virtual interface application in accordance with one embodiment. Shown is a client application window 600, a word processor window 602 and a file viewer window 604.

The client application window 600 is the graphical user interface for the client application that is running on a host computer. The word processor window 602 is a window that displays image information sent from the token device to the host computer. The host computer receives image information from the token device in order to update the view of what is shown in the word processor window 602, however, the host device never has access to the file or application that is stored on the token device. The word processing application running on the token device will be described below in greater detail.

The file viewer window 604 is a window that displays image information sent from the token device to the host computer. Again, the host computer receives image information from the token device in order to update the view of what is shown in the file viewer window 604, however, the host device never has access to the file or application that is stored on the token device. The file view application running on the token device will be described below in greater detail.

In current systems, distribution of highly sensitive documents (usually encrypted) can be accomplished with various existing technologies. However, once the document is delivered, the recipient needs to decrypt the document in order for it to be viewed. Once the document is decrypted it can be stored in a non-secure manner and/or can be delivered to another person who is not authorized to view the document. In addition, the computer utilized to view the document may maintain a copy of the document in the cache of the computer. Thus, there are problems with existing technology when viewing and editing highly sensitive documents.

There are many existing models related to DRM (digital rights management) that attempt to control the access and distribution of document and application. These existing systems are often defeated once access is granted to a specific file or application and the host computer executes another program that reads the host computer memory and records the file or application being accessed.

The following embodiments solve the above problems and address other problems with current systems. In one embodiment, the token device is in the form-factor of a smart card and utilizes the smart card interface. The token device is used to view a secure document. The document will be shown in the file viewer window 604 using image information sent from the token device to the host computer. In operation, the token device is connected to a host device through the smart card interface. Next, a drive (e.g., a read/write drive) on the token device is made available to the host device. A file that has been encrypted using, for example, a public key or shared secret for a specific token device is delivered to a user (e.g., by email, CD or network download) and the encrypted file is copied to the token device.

The virtual interface program (i.e., the client application) is started on the host device and the file viewer window 604 appears in the window of the client application. In one embodiment, the file viewer window 604 is used by the user to select a file (e.g., an encrypted file) stored on the token device. The encrypted file is automatically decrypted by the token device (e.g., using the token device's private key or the shared secret) and displayed in the file viewer window 602. Image information is transferred from the token device to the virtual interface program in order to update what is shown in the file view window 604. Similarly to the other examples given, a user can interact with the file viewer window 604 using an input device on the host computer (e.g., a mouse or keyboard). During interaction, the client application will record any inputs on the host device (e.g., mouse and keyboard inputs) and send them to the file viewer application that is running on the token device. The file viewer application (virtual server application) interprets the inputs and updates the image information that is sent to the client application. Upon receipt of the updated image information, the client application will update the image in the file viewer window 604. In this manner, the encrypted file is never available to the host computer in a decrypted state, however, the user is able to view the file through the virtual interface on the host computer.

After viewing is complete, the encrypted file can be removed from the token device and discarded or archived using another storage medium. The file is still encrypted so it can be transferred and stored without concern of unauthorized viewing.

Now turning to the word processing window 602. Creation and editing of highly sensitive or secret documents is often performed on computer systems specifically designated for working with sensitive documents. Often the computer is in a locked room and utilizes very strong access controls to ensure only valid users have access. Even when dealing with a document that would generally not be considered as very highly sensitive or a secret document, people often consider their financial information, calendar, or even contact list to be very sensitive. Further, it may be necessary to edit files when away from the computer that is normally utilized to edit the files (for example the computer at home or the office). For example, this can occur when visiting a client, when traveling, or when it necessary to utilize a public computer, for example, at an internet cafe. In such situations, a user may not want the public computer to have access to the document for many of the reasons stated herein, however, the user may need to access and edit the document.

The following embodiments solve the above problems and address other problems with current systems. In operation, the token device is connected to a host device through an interface. The token device is, for example, in the form factor of a USB device using a USB interface. After inserting the token device into a USB slot of a host computer, a read only drive optionally appears on the host computer. The client application that runs on the host device is stored on the read only drive of the token device. As described above, the client application alternatively can be previously loaded on the host device or downloaded over a network (e.g., Internet, wireless, telecommunications) and stored at the host computer.

Next, the client application is launched and run on the host device. This causes the client application window 600 to appear on a display device of the host computer. The client application window can optionally display a desktop interface virtualized from the token device. Alternatively, the word processing window 602 can be immediately shown. After appropriate verification (e.g., password or biometric identification), the word processing application is run on the token device and the desired file can selected for editing. Imaging information is sent from the token device to the host device to update the image shown in word processing window 602. The user uses the input devices of the host device to interact with the word processing application that is running on the token device. Optionally, a portion of the token device can be enabled for read and or read/write access from the host computer. Additionally, printing is possible using the virtual client application to enable access to a printer that is accessible to the host computer.

Again, it should be understood that the host computer is not running the word processing application but is only running the client application. The client application receives image information from the token device to allow the viewer to interact with the word processing application.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

I claim:

1. A token device comprising:
a memory;
an interface for coupling the token device to a host device; and
a processor coupled to the memory, the processor running a token device application stored in the memory of the token device, the processor providing image information to the host device over the interface, the image information for rendering an image corresponding to the application, said image information being transmitted to a client application for rendering on a display of the host device.

2. The token device of claim 1 wherein the client application accepts an input from the host device, wherein the input is routed to the token device.

3. The token device of claim 1 further comprising a read only portion of the memory.

4. The token device of claim 3 wherein the read only portion of the memory stores the client application.

5. The token device of claim 1 further comprising a read and write portion of the memory.

6. The token device of claim 1 wherein the processor is a secure processor.

7. The token device of claim 1 wherein the token device application is a banking application, a point of sale application, a word processing application or a file viewing application.

8. A system comprising:
a host device including a display, the host device running a client application; and
a token device coupled to the host device through an interface, the token device including a processor for running a token device application, the token device application providing image information over the interface to the client application running on the host device, the client application displaying an image on the display of the host device corresponding to the image information provided from the token device.

9. The system of claim 8 further comprising a banking server coupled to the host device through a network.

10. The system of claim 8 further comprising a financial transaction back end coupled to the host device through a network.

11. The system of claim 10 wherein the host device is a transaction terminal.

12. The system of claim 11 where the token device is a smart card.

13. The system of claim 8 further comprising an input device coupled to the host device, wherein the client application accepts an input from the input device of the host device, wherein the input is routed to the token device and interpreted by the token device application.

14. A method of operating a token device comprising:
coupling the token device to a host device through an interface;
running a token device application on the token device;
generating image information; and
sending the image information to the host device through the interface, the image information being rendered by a client application running on the host device.

15. The method of claim 14 further comprising:
publishing a drive on the token device to the host device; and
storing the client application on the drive for download to the host device.

16. The method of claim 14 further comprising sending a message to a bank server through the host device, wherein the token device application comprises a banking application.

17. The method of claim 16 wherein the message to the bank server is encrypted.

18. The method of claim 14 further comprising sending a message to a financial transaction back end through the host device, wherein the token device application comprises a financial transaction application.

19. The method of claim 14 further comprising receiving input information from the host device corresponding to an input received at the host device.

20. The method of claim 19 further comprising providing the input information to the token device application running on the token device.
